(19) United States
(12) Patent Application Publication
(10) Pub. No.: US 2023/0334290 A1
(43) Pub. Date: Oct. 19, 2023

(54) SYNTHETIC DATA GENERATION USING DEEP REINFORCEMENT LEARNING

(71) Applicant: Microsoft Technology Licensing, LLC, Redmond, WA (US)

(72) Inventor: Kiran RAMA, Bangalore (IN)

(21) Appl. No.: 17/720,212

(22) Filed: Apr. 13, 2022

(51) Int. Cl. G06N 3/04; G06K 9/62

(52) U.S. Cl. CPC G06N 3/0454; G06N 3/0481; G06K 9/6256

(57) ABSTRACT

Systems and method for deep reinforcement learning are provided. The method includes generating, by a first neural network implemented on a processor, a synthetic data set based on an original data set, providing the original data set and the generated synthetic data set to a second neural network implemented on the processor, generating, by the second neural network, a prediction identifying the original data set and the generated synthetic data set, and based at least in part on the prediction incorrectly identifying the generated synthetic data set, exporting the generated synthetic data set.

### BACKGROUND

Large data sets are used to train machine learning (ML) models. However, due to privacy and security concerns, as well as privacy regulations, some large data sets should not and/or are not able to be shared with ML models that would benefit from being trained using these data sets, particularly data sets that include personally identifiable information. This is because the ML model is executed on a device or a server that is physically located in a different location, for example a different geographical location, than where the data is stored or where the data was obtained. Due to the aforementioned privacy and security concerns, these data sets cannot be transferred or shared to the physical location where other ML models are executed and trained.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Examples and implementations disclosed herein are directed to systems and methods that generate synthetic data using deep reinforcement learning. The system includes a memory, a processor, a first neural network, and a second neural network implemented on a server. The first neural network generates a synthetic data set based on an original data set. The original data set and the generated synthetic data set are provided to the second neural network, which generates a prediction identifying the original data set and the generated synthetic data set. Based at least in part on the prediction incorrectly identifying the generated synthetic data set, the generated synthetic data set is exported.

### BRIEF DESCRIPTION OF THE DRAWINGS

The present description will be better understood from the following detailed description read in light of the accompanying drawings, wherein:

FIG. 1 is a block diagram illustrating an example computing device for implementing various examples of the present disclosure;

FIG. 2 is a block diagram illustrating an example system implementing deep reinforcement learning according to various examples of the present disclosure;

FIG. 3 is a flow chart diagram illustrating operations of a computer-implemented method for deep reinforcement learning according to various examples of the present disclosure;

FIG. 4A is a flow chart diagram illustrating operations of a computer-implemented method for generating synthetic data and performing deep reinforcement learning according to various examples of the present disclosure;

FIG. 4B is a flow chart diagram illustrating operations of a computer-implemented method for predicting original and synthetic data sets and performing deep reinforcement learning according to various examples of the present disclosure; and

FIG. 5 is a flow chart diagram illustrating operations of a computer-implemented method for deep reinforcement learning according to various examples of the present disclosure.

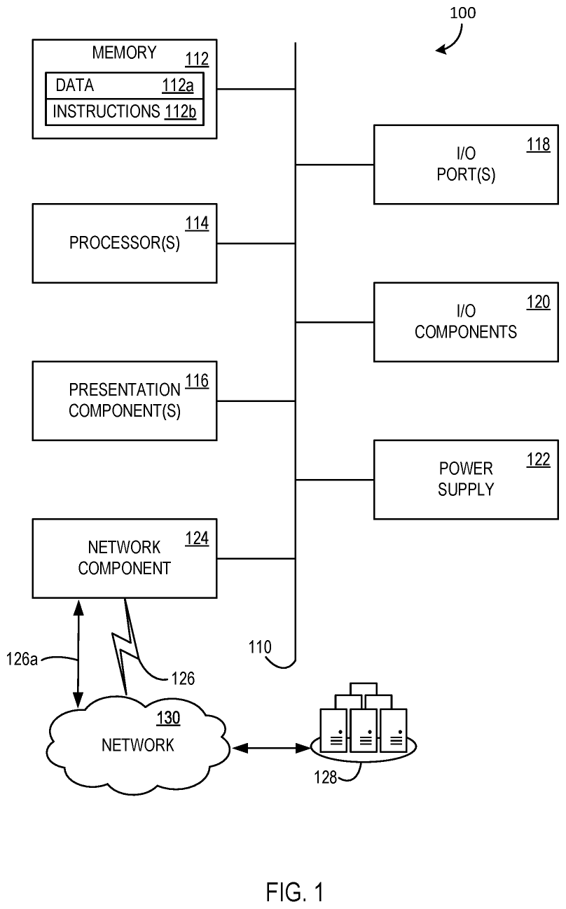

Corresponding reference characters indicate corresponding parts throughout the drawings. In FIGS. 1 to 5, the systems are illustrated as schematic drawings. The drawings may not be to scale.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

As described herein, ML models and other deep neural networks are trained using large data sets. However, due to various privacy and security concerns, these data sets may not be able to be transferred to ML models that utilize them. As a result, some ML models are restricted from using some data and therefore learn less than they otherwise would. Accordingly, various implementations of the present disclosure recognize and take into account the need to provide synthetic data sets that represent original data sets to ML models in order for ML models to learn as effectively as possible. Current solutions fail to provide solutions that ensure the privacy and security of original data while providing synthetic data that is sufficiently robust to effectively train ML models. Current solutions include anonymizing data, which can be decoded and fails to provide rigorous privacy guarantees. Other examples include the implementation of known ML models to generate synthetic data.

Various examples of the present disclosure address the above-identified challenges by introducing two competing deep neural networks, one of which generates synthetic data based on an original data set and one which attempts to identify the original data set and the synthetic data set. Generating a synthetic data set based on, but distinct from, an original data set enables an external ML model to be trained based on realistic data which can be safely exported and transferred without the risk of violating the privacy and security concerns present with the original data set. Both of the competing first and second neural networks continuously learn and optimize in parallel, so that the first deep neural network generates synthetic data that more and more closely resembles the original data set and the second deep neural network more and more effectively distinguishes the synthetic data from the original. What ultimately results is a robust discriminator neural network that, despite its robust nature, fails to correctly identify the generated synthetic data set from the original synthetic data set, indicating the generated synthetic data set sufficiently mimics an original data set and can therefore be exported and used to train another ML model.

The input data to the generator network forms the ‘state’, along-with the ‘reward’. The reward is a measure how unsuccessful the discriminator network was in discriminating the real data, i.e., the original data set, from the fake examples, i.e., the synthetic data set. The ‘action’ taken by the generator network is the distortion of the original input data. The next state is the next set of examples. Accordingly, the tuples of <state, action, reward, nextₛₜₐₜₑ> represent reinforcement learning.

Accordingly, the system provided in the present disclosure operates in an unconventional manner by introducing neural networks competing in parallel to generate a realistic synthetic data set based on an original data set. This system provides several advantages. In addition to the increased performance, the system removes human bias due to a lack of human intervention. As a complex non-linear process, privacy is preserved. The training of a ML model or supervised classifier realizes no performance degradation between the original data set and the synthetic dataset.

Thus, the systems and methods of the present disclosure provide a technical solution to an inherently technical problem by improving the generation of synthetic data sets by optimizing parameters of a first neural network that generates a synthetic data set in response to an analysis conducted by a second competing neural network that predicts whether the synthetic data set is synthetic or original data. After each iteration, also referred to herein as an epoch, of synthetic data generation and prediction, both the first neural network and the second neural network calculate loss and optimize their respective parameters in order to more effectively generate the synthetic data and generate the prediction, respectively. As a result, the system generates robust synthetic data sets that can be exported, without violating privacy and security considerations, for use in training another ML model.

Various implementations of the present disclosure implement stochastic gradient descent to train either one or both of competing neural networks. Gradient descent is an optimization algorithm that finds a local minimum of a particular function. Stochastic gradient descent is an iterative algorithm mathematically minimizes loss, such as cross-entropy loss. By iteratively minimizing loss, parameters for the neural network are iteratively improved as well. By applying stochastic gradient descent to competing neural networks, such as the a generator network ML model and a discriminator network ML model that generate synthetic data and predict whether the synthetic data is original or synthetic, respectively, as described herein, the generated synthetic data is iteratively improved to the point it sufficiently resembles original data and thus is eligible for use in training an additional ML model that, due to privacy or security concerns, cannot or will not use the original data.

FIG. 1 is a block diagram illustrating an example computing device 100 for implementing aspects disclosed herein and is designated generally as computing device 100. Computing device 100 is but one example of a suitable computing environment and is not intended to suggest any limitation as to the scope of use or functionality of the examples disclosed herein. Neither should the computing device 100 be interpreted as having any dependency or requirement relating to any one or combination of components/modules illustrated.

The examples disclosed herein may be described in the general context of computer code or machine- or computer-executable instructions, such as program components, being executed by a computer or other machine. Program components include routines, programs, objects, components, data structures, and the like that refer to code, performs particular tasks, or implement particular abstract data types. The disclosed examples may be practiced in a variety of system configurations, including servers, personal computers, laptops, smart phones, servers, VMs, mobile tablets, hand-held devices, consumer electronics, specialty computing devices, etc. The disclosed examples may also be practiced in distributed computing environments when tasks are performed by remote-processing devices that are linked through a communications network.

The computing device 100 includes a bus 110 that directly or indirectly couples the following devices: computer-storage memory 112, one or more processors 114, one or more presentation components 116, I/O ports 118, I/O components 120, a power supply 122, and a network component 124. While the computing device 100 is depicted as a seemingly single device, multiple computing devices 100 may work together and share the depicted device resources. For example, memory 112 is distributed across multiple devices, and processor(s) 114 is housed with different devices. Bus 110 represents what may be one or more busses (such as an address bus, data bus, or a combination thereof). Although the various blocks of FIG. 1 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 1 and the references herein to a “computing device.”

Memory 112 may take the form of the computer-storage memory device referenced below and operatively provide storage of computer-readable instructions, data structures, program modules and other data for the computing device 100. In some examples, memory 112 stores one or more of an operating system (OS), a universal application platform, or other program modules and program data. Memory 112 is thus able to store and access data 112a and instructions 112b that are executable by processor 114 and configured to carry out the various operations disclosed herein. In some examples, memory 112 stores executable computer instructions for an OS and various software applications. The OS may be any OS designed to the control the functionality of the computing device 100, including, for example but without limitation: WINDOWS® developed by the MICROSOFT CORPORATION®, MAC OS® developed by APPLE, INC.® of Cupertino, Calif., ANDROID™ developed by GOOGLE, INC.® of Mountain View, California, open-source LINUX®, and the like.

By way of example and not limitation, computer readable media comprise computer-storage memory devices and communication media. Computer-storage memory devices may include volatile, nonvolatile, removable, non-removable, or other memory implemented in any method or technology for storage of information such as computer-readable instructions, data structures, program modules, or the like. Computer-storage memory devices are tangible and mutually exclusive to communication media. Computer-storage memory devices are implemented in hardware and exclude carrier waves and propagated signals. Computer-storage memory devices for purposes of this disclosure are not signals per se. Example computer-storage memory devices include hard disks, flash drives, solid state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number an organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device, CPU, GPU, ASIC, system on chip (SoC), or the like for provisioning new VMs when configured to execute the instructions described herein.

Processor(s) 114 may include any quantity of processing units that read data from various entities, such as memory 112 or I/O components 120. Specifically, processor(s) 114 are programmed to execute computer-executable instructions for implementing aspects of the disclosure. The instructions may be performed by the processor 114, by multiple processors 114 within the computing device 100, or by a processor external to the client computing device 100. In some examples, the processor(s) 114 are programmed to execute instructions such as those illustrated in the flow charts discussed below and depicted in the accompanying figures. Moreover, in some examples, the processor(s) 114 represent an implementation of analog techniques to perform the operations described herein. For example, the operations are performed by an analog client computing device 100 and/or a digital client computing device 100.

Presentation component(s) 116 present data indications to a user or other device. Example presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 100, across a wired connection, or in other ways. I/O ports 118 allow computing device 100 to be logically coupled to other devices including I/O components 120, some of which may be built in. Example I/O components 120 include, for example but without limitation, a microphone, joystick, game pad, satellite dish, scanner, printer, wireless device, etc.

The computing device 100 may communicate over a network 130 via network component 124 using logical connections to one or more remote computers. In some examples, the network component 124 includes a network interface card and/or computer-executable instructions (e.g., a driver) for operating the network interface card. Communication between the computing device 100 and other devices may occur using any protocol or mechanism over any wired or wireless connection. In some examples, network component 124 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 124 communicates over wireless communication link 126 and/or a wired communication link 126a across network 130 to a cloud environment 128. Various different examples of communication links 126 and 126a include a wireless connection, a wired connection, and/or a dedicated link, and in some examples, at least a portion is routed through the Internet.

The network 130 may include any computer network or combination thereof. Examples of computer networks configurable to operate as network 130 include, without limitation, a wireless network; landline; cable line; digital subscriber line (DSL): fiber-optic line; cellular network (e.g., 3G, 4G, 5G, etc.); local area network (LAN); wide area network (WAN); metropolitan area network (MAN); or the like. The network 130 is not limited, however, to connections coupling separate computer units. Rather, the network 130 may also include subsystems that transfer data between servers or computing devices. For example, the network 130 may also include a point-to-point connection, the Internet, an Ethernet, an electrical bus, a neural network, or other internal system. Such networking architectures are well known and need not be discussed at depth herein.

As described herein, the computing device 100 can be implemented as one or more servers. The computing device 100 can be implemented as an electronic device in a system 200 as described in greater detail below.

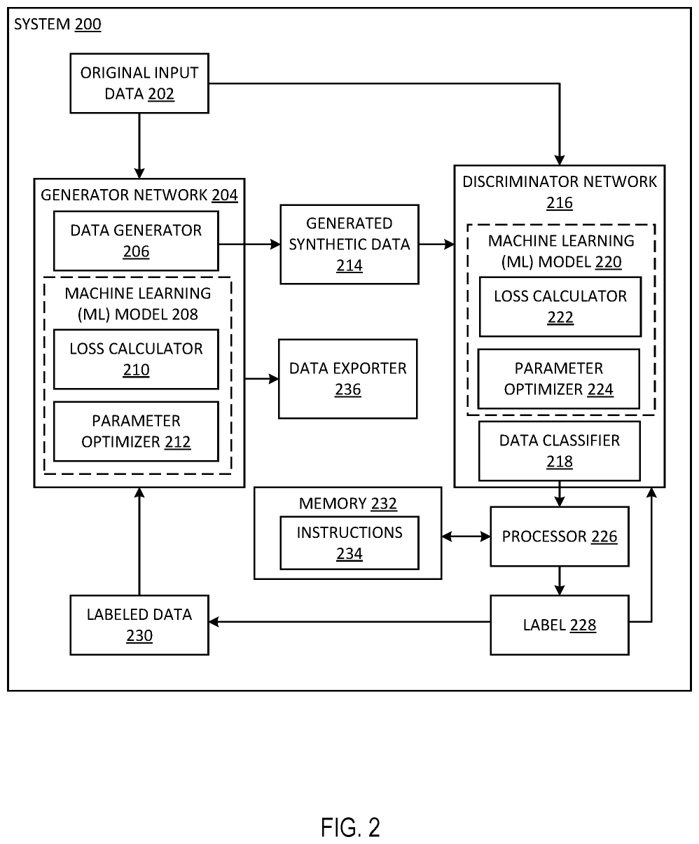

FIG. 2 is a block diagram illustrating an example system implementing deep reinforcement learning according to various examples of the present disclosure. The system 200 can include the computing device 100. In some implementations, the system 200 includes a cloud-implemented server that includes each of the components of the system 200 described herein.

The system 200 includes a memory 232 and a processor 226 that executes instructions 234 stored on the memory 232. In some implementations, the memory 232 is the memory 112, the instructions 234 stored on the memory 232 are the instructions 112b, and the processor 226 is the processor 114. The system 200 further includes a generator network 204 and a discriminator network 216. The generator network 204 and the discriminator network 216 can be executed by the processor 226 executing the instructions 234 stored on the memory 232. The generator network 204 and the discriminator network 216 will be described in greater detail below.

In some implementations, the memory 232 also stores original input data 202. In some implementations, the original input data 202 includes one or more data sets. The original input data 202 can include any type of data. In some implementations, the original input data 202 includes personally identifiable information of one or more users, consumers, customers, employees, vendors, and so forth in combination with one or more data fields. However, this example should not be construed as limiting. Various implementations are possible. In some implementations, the original input data 202 is provided in a table comprising up to hundreds or thousands of rows of data and up to hundreds or thousands of columns of data. For example, the original input data 202 can be a dataset X including m rows and n columns.

In some implementations, the original input data 202 is subject to restrictions on how and where it is collected, transferred, and stored. For example, the original input data 202 can be subject to security and privacy concerns that restrict the original input data 202 from being transferred and stored in a location other than where it was originally obtained. The location can include a physical location, such as a facility, or a geographic area, such as a county, city, state, country, and so forth. In compliance with these requirements and best practices, the original input data 202 is co-located with the generator network 204 and the discriminator network 216 which use the original input data 202 as an input. In other words, the original input data 202 is stored on the memory 232 in a same location with the generator network 204 and the discriminator network 216. In some implementations, the original input data 202 is stored in the same physical location, such as a facility, as the generator network 204 and the discriminator network 216. In other implementations, the original input data 202 can be stored in a different physical location, such as a different facility, than the generator network 204 and the discriminator network 216 but within the same geographic area so as to comply with local security and privacy regulations and best practices guidelines.

Each of the generator network 204 and the discriminator network 216 is a deep neural network, also referred to herein as a deep learning network. In some examples, the generator network 204 is referred to herein as a first neural network and the discriminator network 216 is referred to herein as a second neural network. However, the use of the descriptions first and second are merely for ease of explanation and should not be construed as limiting. Various examples can refer to the discriminator network 216 as The generator network 204 and the discriminator network 216 execute in parallel in order to optimize the synthetic data iteratively generated by the generator network 204.

The generator network 204 includes a data generator 206 and a machine learning (ML) model 208. The ML model 208 can be referred to herein as a first ML model. The data generator 206 iteratively generates a synthetic data set, for example the synthetic data 214., corresponding to the original input data 202. The ML model 208 includes a loss calculator 210 and a parameter optimizer 212. The loss calculator 210 calculates a loss of the synthetic data 214 based on receiving labeled input data 230 as described in greater detail below. Based on the calculated loss, the parameter optimizer 212 adjusts, updates, or optimizes, parameters of the data generator 206, which then generates a next iteration of the synthetic data 214 based on the original input data 202. In some implementations, the ML model 208 is trained using stochastic gradient descent.

The discriminator network 216 receives the iteration of the synthetic data 214 as well as the original input data 202. In some implementations, the synthetic data 214 and the original input data 202 are randomly assigned a label, such as 0 and 1, in order to mask from the discriminator network 216 which dataset is the original and which is synthetic. The discriminator network 216 includes a data classifier 218 and a machine learning (ML) model 220. The ML model 220 can be referred to as a second ML model. In some implementations, the ML model 220 is trained using stochastic gradient descent.

The data classifier 218 generates a prediction that predicts which of the original input data 202 and the synthetic data 214 is the original data and which is the synthetic data. In other words, the data classifier 218 outputs a prediction either identifying the original input data 202 as the original data and the synthetic data 214 as the synthetic data, or identifying the original input data 202 as the synthetic data and the synthetic data 214 as the original data. Accordingly, the data classifier 218 either correctly predicts the synthetic and original data, or incorrectly predicts the synthetic and original data.

To output the prediction, the data classifier 218 labels the input original input data 202 and the synthetic data 214. For example, the data classifier 218 can use a binary labeling system where the predicted original data is labeled with a 0 and the predicted synthetic data is labeled with a 1, or vice versa. The processor 226 compares the prediction output by the data classifier 218 to the labels randomly assigned to the synthetic data 214 and the original input data 202 prior to the discriminator network 216 receiving the data. In implementations where the discriminator network 216 correctly predicted the original input data 202 and the synthetic data 214, the processor outputs a label 228 of 0 to be returned to each of the generator network 204 and the discriminator network 216. In implementations where the discriminator network 216 incorrectly predicted the original input data 202 and the synthetic data 214, the processor outputs a label 228 of 1 to be returned to each of the generator network 204 and the discriminator network 216.

The label 228 provides an indication to each of the generator network 204 and the discriminator network 216 regarding the results of the prediction generated by the data classifier 218. In implementations where the label 228 is a 0 indicating the data classifier 218 correctly predicted the original and synthetic data, the label 228 is returned to the discriminator network 216 as positive feedback indicating a correct prediction. The label 228 is also attached to the synthetic data 214 as labeled data 230 and returned to generator network 204 as negative feedback, because the iteration of the synthetic data 214 was not realistic enough to fool the discriminator network 216 into predicting it was original data. In contrast, in implementations where the label 228 is a 1 indicating the data classifier 218 incorrectly predicted the original and synthetic data, the label 228 is returned to the discriminator network 216 as negative feedback indicating an incorrect prediction. The label 228 is also attached to the synthetic data 214 as labeled data 230 and returned to generator network 204 as positive feedback, because the iteration of the synthetic data 214 was sufficiently realistic to fool the discriminator network 216 into predicting it was original data.

The labeled data 230 includes the synthetic data 214, to indicate the particular iteration of the synthetic data, and the label 228 generated by the processor 226 indicating whether the data classifier 218 correctly or incorrectly predicted the synthetic data 214 and the original input data 202. The label 228 can be applied using any suitable method of labeling data. For example, the label 228 can be applied as a header of the synthetic data 214, appended to the front or tail end of the synthetic data 214, the file name of the synthetic data 214 can be changed to include the label 228, or any other suitable method.

The generator network 204 and the discriminator network 216 execute the ML models 208 and 220 after receiving the labeled data 230 and the label 228, respectively. As described in greater detail below, the loss calculator 210 calculates a loss of the synthetic data 214 based on the labeled data 230. Based on the calculated loss, the parameter optimizer 212 adjusts parameters of the data generator 206, which then generates a next iteration of the synthetic data 214 based on the original input data 202. Similarly, the loss calculator 222 calculates a loss of the prediction of the data classifier 218 based on the label 228. Based on the loss, the parameter optimizer 224 adjusts, updates, or optimizes, parameters of the data classifier 218, which then generates a prediction regarding the next iteration of received synthetic data 214 and the original input data 202.

The system 200 further includes a data exporter 236. After one or more iterations of generating the synthetic data 214 and processing the synthetic data 214 through the discriminator network 216, the synthetic data 214 is deemed to be similar enough to the original input data 202 to be used to train an external ML model. The synthetic data 214 can be automatically determined to be similar enough to the original input data 202 by being predicted as original data by the data classifier 218 a number of times that exceeds a threshold. In some implementations, the threshold is one. In other words, the first time the synthetic data 214 is predicted as original data, the data exporter 236 exports the synthetic data 214 for use in training an external ML model. In other implementations, the threshold is greater than one. In other words, the synthetic data 214 should be predicted as original data more than one time by the data classifier 218 before being marked as realistic enough to be exported by the data exporter 236.

The external ML model described herein can be any ML model trained using the synthetic data 214. The external ML model is different than the ML model 208 and the ML model 220. Although described as an external ML model, this example should not be construed as limiting. The external ML model can be included in the system 200 but is different and distinct from the ML model 208 and the ML model 220.

In some implementations, the system 200 is referred to as a deep reinforcement learning system. Deep reinforcement learning includes a state, action, and reward. For example, the state is the value of the input features in an observation, such as the original input data 202. The action is continuous and includes the synthetic data 214, which includes all the changes to the original input data 202 such as distortion, introduced noise, synthetic data values, and so forth. The reward is generated based on the competing generator network 204 and discriminator network 216, which results in an output of the labeled data 230 that is returned to the generator network 204 for additional optimization of the parameters used to generate the synthetic data 214.

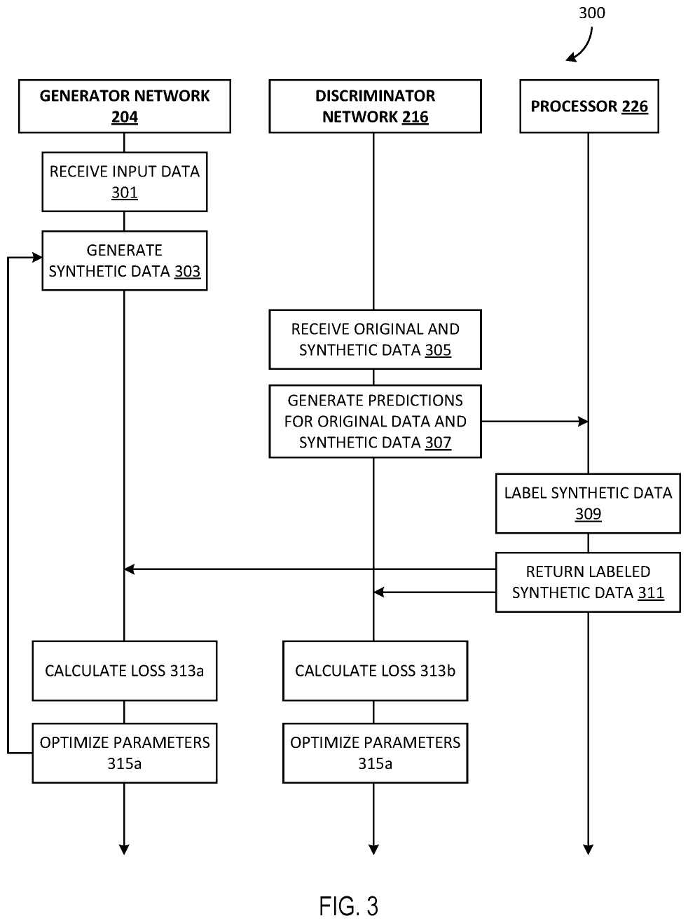

FIG. 3 is a flow chart diagram illustrating operations of a computer-implemented method for deep reinforcement learning according to various examples of the present disclosure. The operations illustrated in FIG. 3 are for illustration and should not be construed as limiting. Various examples of the operations can be used without departing from the scope of the present disclosure. The operations of the flow chart 300 can be executed by one or more components of the system 200, including the generator network 204, the discriminator network 216, and the processor 226.

The method 300 begins by the generator network 204 receiving original input data 202 in operation 301. The original input data 202 can be provided in various formats, including but not limited to a .csv file, an .xml file, a .xlsx file, a .txt file, or as any other file type. In some implementations, the original input data 202 is provided in a file format including one or more columns and one or more rows. In one particular example, the original input data 202 can be a dataset X including m rows and n columns. The original input data 202 can be provided as textual data, numeric data, or a combination of textual and numeric data. For example, some data can be provided as numeric data while other data is provided as textual data, such as where personally identifiable information is followed by numeric data including birthdays, social security numbers, financial account information, card numbers, and so forth. Other data can include a combination of text and numeric data within a single data field, such as an address.

In operation 303, the generator network 204 generates synthetic data based on, or corresponding to, the original input data 202. For example, the synthetic data 214 includes similar data, including the same types of data fields, the same quantity of data fields, and similar patterns as the data fields of the original input data 202. The generator network 204 distorts the feature values of the original input data 202 to introduce noise and create synthetic data values which are close to those of the original input data 202 without any meaningful reconstruction of the original data. The original input data 202 forms the state aspect of the deep reinforcement learning process. As referenced above, the dataset X includes X_{cat} and X_{cont}, the categorical and continuous parts of the dataset X, respectively. The variables in X_{cat} are one-hot encoded. The distortion is applied to the original input data 202 by passing the original input data 202 through a series of alternating affine and non-linear activation functions. The affine transformation has the linear form W. X+b where W is the weight matrix and X is the input data. The non-linear transformation is the ReLU function that the form of: ReLU(X)=X if X>0 and ReLU(X)=0 if X≤0.

The output of the generator network 204 is denoted by G(X) for the distorted input. For example, in the generator network 204, where there are several layers, each layer is denoted by Lᵢ, and applies an affine transformation followed by a non-linear activation. Each layer Lᵢ has the same shape as the prior layer, with each layer applying the affine transformation followed by the non-linear transformation at each step:

G_{X}=ReLU(Wₖ(ReLU(Wₖ₋₁( . . . ReLU(W₀X+B₀)

Thus, the output has the same form as the input and is distorted through the application of several affine and non-linear activations at the different layers. The reconstructed input has a fully connected layer to a single node at the output. This output tries to minimize the accuracy of the discriminator network. This output is denoted by

Generator_{X}=σ(W_{final}·G_{X}+b_{X})

For example, where the original input data 202 includes information about a consumer indicating an original age and an original purchase history, a realistic version of the synthetic data 214 may include an age similar to but different than the original age with a purchase history similar to but different from the original purchase history. This data is similar to the original input data 202, by including the same pattern of age range and purchase history, and thus can be used to train an external ML model as effectively as the original input data 202 while maintaining the privacy and security concerns of the user by not directly using their personal information. However, it should be understood that in some implementations, the generator network 204 may take several iterations of generating the synthetic data 214 before the synthetic data 214 is considered realistic. For example, unrealistic versions of the synthetic data 214, particularly early iterations, may generate synthetic data indicating an age much younger or older than the original age and purchase history quite different from the original purchase history but with the same distributions such that the any ML model built on top of the synthetic data generates similar results, thereby as an example of privacy-preserving.

In some implementations, the generator network 204 generates the synthetic data 214 based on the original input data 202 in segments. For example, where the original input data 202 includes multiple rows and multiple columns, the generator network 204 may generate the synthetic data 214 one row or one column at a time. In other words, in operation 303 the generator network 204 generates one row of synthetic data 214 corresponding to the first row of the original input data 202 and operations 303 through 315 are iteratively executed until the synthetic data 214 is determined to be sufficiently realistic. Once the first row of the original input data 202 has been synthesized, the generator network 204 proceeds to the second row of the original input data 202 and iteratively executes operations 303 through 315. Accordingly, the method 300 is iteratively executed for each row of the original input data 202 until the entirety of the original input data 202 is synthesized, i.e., until sufficient synthetic data 214 has been generated for the entirety of the original input data 202. Although operations 303 through 315 are described herein as being iterated for the original input data 202 row by row, this example should not be construed as limiting. In some implementations, operations 303 through 315 can be iterated for the original input data 202 column by column.

In operation 305, the discriminator network 216 receives a labeled version of each of the original input data 202 and the synthetic data 214. For example, the discriminator network receives the original input data 202 labeled with a 0 and the synthetic data 214 labeled with a 1. In another example, the discriminator network receives the original input data 202 labeled with a 1 and the synthetic data 214 labeled with a 0. The labels of 0 and 1 are applied in order to mask, to the discriminator network, which data set is the original data and which is synthetically generated. In some implementations, the labels are applied by the processor 226. The label of 0 or 1 can be applied as a header to the data, appended to the front or tail end of the data, the file name of the data can be changed to include the label, or any other suitable method. In some implementations, the input to the discriminator network 216 is provided as the concatenation of X and G_{X} as X,G_{X}=[X|G_{X}].

In operation 307, the discriminator network 216 generates a prediction identifying the original input data 202 and the synthetic data 214. Two options are possible for the prediction. The prediction can either be correct and accurately identify the original input data 202 and the synthetic data 214 or be incorrect and identify the synthetic data 214 as the original data. The prediction is generated by passing the original input data 202 and the synthetic data 214 through a classifier, such as the data classifier 218, which distinguishes between the 0's and 1's of the labeled data passed to the discriminator network 216. In some implementations, the discriminator network 216 calculates a forward pass, i.e., the generated prediction, as Discriminator_{X,G}_{_{X}}=σ(Hₖ(ReLU(Hₖ₋₁( . . . ReLU(H₀[X|G_{X}]+B₀). The generated prediction is pushed to the processor 226.

In operation 309, the processor 226 labels the synthetic data 214 with the label 228 based on the generated prediction by the discriminator network 216. As described above, the label 228 is a binary representation of the accuracy of the generated prediction, where a 0 indicates a correct prediction and a 1 indicates an incorrect prediction. The label 228 is appended to the synthetic data 214 to generate the labeled data 230.

In operation 311, the processor 226 returns the labeled data 230 to the generator network 204 and the discriminator network 216. Based on the labeled data 230, each of the generator network 204 and the discriminator network 216 execute ML models, i.e., the ML model 208 and the ML model 220, respectively, in order to improve functionality. More specifically, the ML model 208 receives the labeled data 230 as feedback and, in operation 313a, computes, or calculates, a loss of the iteration of the synthetic data 214. For example, the generator network 204 calculates the loss as Loss_{G}=−X*log(Discriminator_{X,G}_{_{X}})−(1−X)*(1−log(Discriminator_{X,G}_{_{X}})). Similarly, the ML model 220 receives the labeled data 230 as feedback and, in operation 313b, computes, or calculates, a loss of the generated prediction for the iteration of the synthetic data 214. For example, the discriminator network 216 calculates the loss as Loss_{D})=−[X|G_{X}]*log(Discriminator_{X,G}_{_{X}})−(1−[X|G_{X}])*(1−log(Discriminator_{X,G}_{_{X}})).

The losses of the generator network 204 and the discriminator network 216 can be calculated simultaneously with regards to the unknowns W_{K}, W_{final}, H_{K}, and all the bias terms B. Although the loss calculations are referred to herein as simultaneously calculated, it should be understood that some variations may be present in the time required to calculate the losses. For example, simultaneous should be understood to mean occurring at approximately the same time such that overlap in the timing is expected. Calculating the loss of the generator network 204 may take more or less time than calculating the loss of the discriminator network 216 without departing from the scope of the disclosure.

In operation 315a, the calculated loss is then used to improve the parameters of the data generator 206. In operation 315b, the calculated loss is then used to improve the parameters of the data classifier 218. For example, the parameter optimizer 212 can back propagate the loss by subtracting the gradients of the loss and thereby minimizing the values of W_{K}, W_{final}, H_{K}, and all the bias terms B in the opposite direction of the gradient. Likewise, the parameter optimizer 224 can back propagate the loss by subtracting the gradients of the loss and thereby minimizing the values of W_{K}, W_{final}, Hₖ, and all the bias terms B in the opposite direction of the gradient.

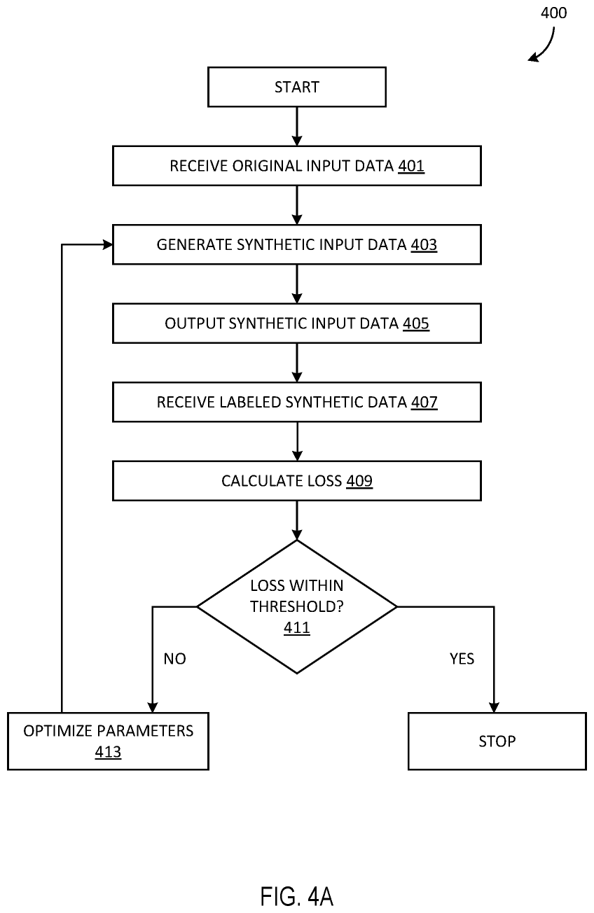

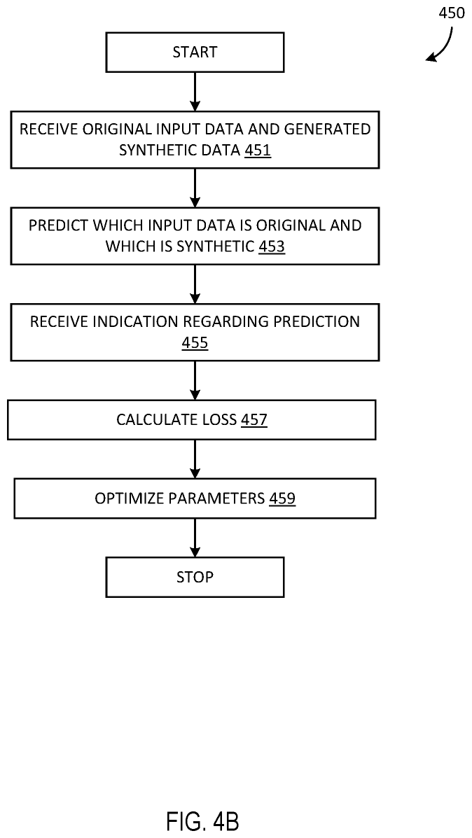

It should be understood that operations 313a, 313b, 315a, and 315b can be executed in any order. For example, the generator network 204 can execute operations 313a and 315a prior to the discriminator network 216 executing operations 313b and 315b, or the discriminator network 216 can execute operations 313b and 315b prior to the generator network 204 executing operations 313a and 315a. In other implementations, the generator network 204 executes operations 313a and 315a and the discriminator network 216 executes operations 313b and 315b simultaneously. Operations 313a and 315a will be described in greater detail below with regards to FIG. 4A and operations 313b and 315b will be described in greater detail below with regards to FIG. 4B.

Following the generator network 204 completing the execution of operation 315a, the method 300 returns to operation 303 and generator network 204 generates the next iteration of synthetic data 214 based on the parameters that were improved in operation 315a. This is the beginning of a second epoch. The operations of the method 300 continue until the generator network 204 has generated synthetic data 214 that the discriminator network 216 is unable to accurately distinguish from the original input data 202.

Accordingly, the generator network 204 and the discriminator network 216 operate in parallel as competing neural networks. The generator network 204 iteratively generates synthetic data, which is continually improved by the execution of operations 313a and 315a in each iteration of the method 300. Likewise, the discriminator network 216 iteratively generates a prediction of the synthetic data 214 and the original input data 202, which is continually improved by the execution of operations 313b and 315b in each iteration of the method 300. The result is a first neural network generating improved synthetic data and a second neural network generating improved predictions regarding the synthetic data, which in turn continually improves the first neural network.

As described herein, operations 303 through 315 are iteratively repeated for each row or column of the original input data 202. As each row (or column) is completed, the data exporter 236 appends the completed row (or column) to the generated synthetic data set. Once each row (or column) has been synthesized, the data exporter 236 exports the data to the external ML model that will use the generated synthetic data set for training.

Each iteration of generating a single set of the synthetic data 214, processing the iteration of the synthetic data 214 through the discriminator network 216, returning the results of the prediction to the generator network 204 and the discriminator network 216, and executing the ML model 208 and the ML model 220 to calculate the loss and optimize the parameters of the data generator 206 and data classifier 218, respectively, is referred to as an epoch. A batch of the original input data 202 can be referred to a state that is passed through the system 200. The generation of the synthetic data 214 is referred to as an action, and the labeled data 230 is referred to as the reward.

In some implementations, the method 300 initializes parameters of the generator network 204 and the discriminator network 216 to random values. In other words, all values of Wₖ, W_{final}, Hₖ, and all the bias terms B are initialized to random values. The number of epochs (num_epochs) can be 100, the batch size (batch_size) can be 32, and the number of batches (num_batches)=number of observations (num_observations) divided by the batch size (batch_size).

For each epoch in the range (1:num_epochs), operations 303-315 are executed. In other words, a forward pass, i.e., synthetic data 214, of the generator network 204 is computed, the labeled original input data 202 and synthetic data 214 are input to the discriminator network 216, the forward pass, i.e., the prediction, of the discriminator network 216 is generated, losses for the generator network 204 and the discriminator network 216 are computed, the losses are differentiated, and the parameters for each of the generator network 204 and the discriminator network 216 are optimized.

FIG. 4A is a flow chart diagram illustrating operations of a computer-implemented method for generating synthetic data and performing deep reinforcement learning according to various examples of the present disclosure. The operations illustrated in FIG. 4A are for illustration and should not be construed as limiting. Various examples of the operations can be used without departing from the scope of the present disclosure. The operations of the flow chart 400 can be executed by one or more components of the system 200, including the generator network 204.

The method 400 begins by the generator network 204 receiving original input data 202 in operation 401. As described herein, the original input data 202 can be provided in various file formats and includes one or more rows and one or more columns that create data fields including textual data, numeric data, or a combination of textual and numeric data. In one particular example, the original input data 202 can be a dataset X including m rows and n columns.

In operation 403, the data generator 206 generates synthetic data 214 based on, or corresponding to, the original input data 202. The data generator 206 can generate the synthetic data 214 in segments, such as row by row or column by column. By generating the synthetic data 214 in segments, the data generator 206 is able to receive more precise feedback for each iteration of the synthetic data 214 and more effectively generate a full synthetic data set that can be exported for use by an external ML model. The generator network 204 distorts the feature values of the original input data 202 to introduce noise and create synthetic data values which are similar to those of the original input data 202 without any meaningful reconstruction of the original data. The original input data 202 forms the state aspect of the deep reinforcement learning process.

As referenced above, the dataset X includes X_{cat} and X_{cont}, the categorical and continuous parts of the dataset X, respectively. The variables in X_{cat} are one-hot encoded. The distortion is applied to the original input data 202 by passing the original input data 202 through a series of alternating affine and non-linear activation functions. The affine transformation has the linear form W.X+b where W is the weight matrix and X is the input data. The non-linear transformation is the ReLU function that the form of: ReLU(X)=X if X>0 and ReLU(X)=0 if X≤0.

In some implementations, the original input data 202 includes textual data in addition to or instead of numeric data. For example, the textual data can indicate a name, address, or any other textual data. In order to generate synthetic data 214 corresponding to the textual data, the data generator 206 utilizes a mapping or hashing functions that generates a hash based on the original textual data. Synthetic textual data can be generated by embeddings where an m-dimensional input space is mapped to a k-dimensional embedding space such that k<<m. In this way, the text features are hashed on to a much lower representation and the weights for the same Wₖcan be learned as part of the stochastic gradient descent.

In operation 405, the data generator 206 outputs the synthetic data 214. The output can be denoted by G_{X} for the distorted input. In some implementations, the generator network 204 includes several layers, each layer denoted by Lᵢ, that apply an affine transformation followed by a non-linear activation. Each layer has the same shape as the prior layer, with each layer applying the affine transformation followed by the non-linear transformation at each step. Accordingly, the synthetic data 214 G_{X} can be expressed as G_{X}=ReLU(Wₖ(ReLU(Wₖ₋₁( . . . ReLU(W₀X+B₀). Thus, the output, i.e., the synthetic data 214, has the same form as the input, i.e., the original input data 202, and is distorted through the application of several affine and non-linear activations at the different layers. The reconstructed input has a fully connected layer to a single node at the output. This output tries to minimize the accuracy of the discriminator network 216. This output is denoted by Generator_{X}=σ(W_{final}·G_{X}+b_{X}). The synthetic data 214 is output, randomly labeled, and provided to the discriminator network 216 along with the original input data 202 as described herein.

In operation 407, the generator network 204 receives the labeled data 230 from the processor 226. The labeled data 230 includes the synthetic data 214 and the label 228 indicating whether the synthetic data 214 was correctly identified as synthetic by the discriminator network 216 or incorrectly predicted as original data. The process of the discriminator network 216 generating a prediction regarding the synthetic data 214 is described in greater detail below in the description of FIG. 4B.

In operation 409, the loss calculator 210 calculates the loss based on the received labeled data 230. In some implementations, the loss is cross-entropy loss of the generator network 204. The calculated loss indicates an accuracy of the synthetic data 214. The accuracy can be measured from 0 to 1, where a high loss, i.e., 1 indicates a lower accuracy of the synthetic data 214 and a low loss, i.e., closer to 0, indicates a higher accuracy of the synthetic data 214. As referenced herein, the accuracy of the synthetic data 214 refers to how accurately the synthetic data 214 resembles the original input data 202. The lower the calculated loss, the more accurately, or closely, the synthetic data 214 resembles the original input data 202. In some implementations, the loss is defined as:

Loss_{G}=−X*log(Discriminator_{X,G}_{_{X}})−(1−X)*(1−log(Discriminator_{X,G}_{_{X}})).

For example, log(1)=0. Thus, where actual=predicted, the loss becomes zero, indicating a high accuracy and the synthetic data 214 closely resembles the original input data 202. However, where the actual=1 the loss becomes 1, indicating a low accuracy and the synthetic data 214 does not closely resemble the original input data 202.

In some implementations, the loss calculator 210 compares the calculated loss to a threshold, which is used to determine whether the synthetic data 214 is acceptable for use in training an external ML model. Where the loss is not within the threshold, the method 400 proceeds to operation 413. In operation 413, the parameter optimizer 212 optimizes parameters used by the data generator 206 to generate the next iteration of the synthetic data 214. For example, the parameter optimizer 212 can back propagate the loss by subtracting the gradients of the loss and thereby minimizing the values of Wₖ, W_{final}, Hₖ, and all the bias terms B in the opposite direction of the gradient.

In implementations where the loss is determined to be within the loss threshold, the synthetic data 214 is deemed acceptable for use in training an external ML model and the method 400 terminates. Although the synthetic data 214 is described herein as being acceptable for use in training an external ML model after one iteration of having the loss be within a threshold, various implementations are possible. For example, a single iteration of synthetic data 214 may be required to have a loss below the threshold a specified number of times in order to more accurately confirm that the iteration of the synthetic data 214 is sufficiently accurate. In some implementations, the iteration of synthetic data 214 should have a loss below the threshold two times, three times, five times, or any other suitable number of times determined by the processor 226. In other implementations, the iteration of synthetic data 214 should indicate a loss below the threshold a particular percentage of times through the discriminator network 216. For example, the iteration of the synthetic data 214 can pass through the discriminator network 216 a specified number of times, such as two, five, ten, and so forth. To determine the iteration of the synthetic data 214 is accurate, a certain percentage of the times should indicate a loss below the threshold in operation 411.

FIG. 4B is a flow chart diagram illustrating operations of a computer-implemented method for predicting original and synthetic data sets and performing deep reinforcement learning according to various examples of the present disclosure. The operations illustrated in FIG. 4B are for illustration and should not be construed as limiting. Various examples of the operations can be used without departing from the scope of the present disclosure. The operations of the flow chart 450 can be executed by one or more components of the system 200, including the discriminator network 216.

The method 450 begins by the discriminator network 216 receiving original input data 202 and synthetic data 214 based on the original input data 202 in operation 451. In some implementations, the synthetic data 214 and the original input data 202 are randomly assigned a label, such as 0 and 1, in order to mask from the discriminator network 216 which dataset is the original and which is synthetic. For example, the discriminator network 216 can receive the original data input 202, i.e., the dataset X, with a label of 0 and the synthetic data 214, i.e., G_{X}, with a label of 1. The input to the discriminator network 216 can be expressed as the concatenation of X and G_{X}, as X,G_{X}=[X|G_{X}], where Discriminator_{X,G}_{_{X}}=σ(Hₖ(ReLU(Hₖ₋₁( . . . ReLU(H₀[X|G_{X}]=B₀). It should be understood that the concatenation of X and G_{X} as X,G_{X}=[X|G_{X}] is labeled as 1 for the fake examples and 0 for the original examples.

In operation 453, the data classifier 218 predicts which of the original input data 202 and the synthetic data 214 is the original data and which is the fake data. The data classifier 218 executes alternating affine and non-linear activation functions, reducing in dimensionality to the last layer. The weights of the discriminator network 216 are denoted by Hₖ where k is the number of the layer in the discriminator network 216. The output of the data classifier 218 Discriminator_{X,G}_{_{X}} is the generated prediction. The prediction of the discriminator network 216 is labeled as 1 if the synthetic data is identified correctly and labeled 0 otherwise. A probability score between 0 and 1 indicates the confidence of the discriminator network 216 in getting the prediction correct. The loss function is designed such that there is a high penalty when the predicted output of the discriminator network 216 is incorrect.

In operation 455, the discriminator network 216 receives an indication, from the processor 226, regarding the results of the generated prediction. The results can be provided in the form of the label 228. For example, the label can be a binary indication, such as a 0 indicating the prediction was correct or a 1 indicating the prediction was incorrect.

In operation 457, the loss calculator 222 calculates the loss of the generated prediction. The loss function of the discriminator network 216 is designed to have a large loss if the discriminator network 216 incorrectly predicts the original input data 202 and the synthetic data 214. For example, where the actual label was 1 and the discriminator network 216 generated a prediction of 0, the prediction is incorrect. The second term of Loss_{D} is 0 and the first term becomes −1*log(0), which is −1*−Inf=Inf, a very large value. Similarly, where the actual label was 0 and discriminator network 216 generated a prediction of 1, the prediction is also incorrect. The first term of Loss_{D} becomes 0 and the second term becomes −(1-0)*log(0), which is again infinity.

When both the actual label and predicted label are 1, the discriminator network 216 correctly predicted which data was synthetic data and which data was original data. Here, the Loss_{D} becomes 0 as the second term is irrelevant and the first term is −1*log 1=−1*0=0, indicating no loss. Similar, when both the actual label and the predicted label are 0, the discriminator network 216 correctly predicted which data was synthetic data and which data was original data. Here, the first term is 0 and the second term becomes 0, indicating no loss.

In operation 459, the parameter optimizer 224 optimizes parameters of the data classifier 218 based on the calculated loss. For example, the parameter optimizer 224 can back propagate the loss by subtracting the gradients of the loss and thereby minimizing the values of Wₖ, W_{final}, Hₖ, and all the bias terms B in the opposite direction of the gradient.

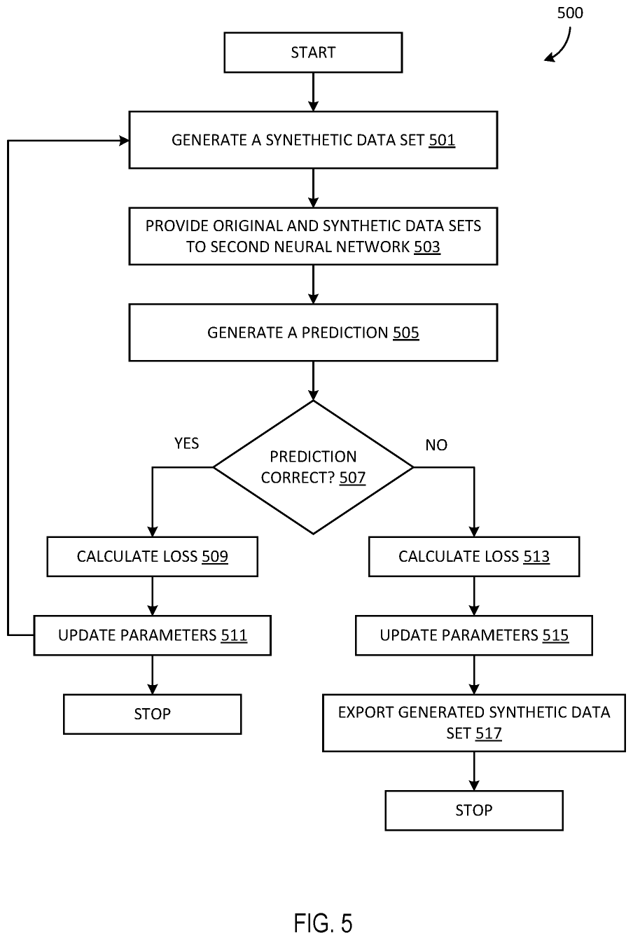

FIG. 5 is a flow chart diagram illustrating operations of a computer-implemented method for deep reinforcement learning according to various examples of the present disclosure. The operations illustrated in FIG. 5 are for illustration and should not be construed as limiting. Various examples of the operations can be used without departing from the scope of the present disclosure. The operations of the flow chart 500 can be executed by one or more components of the system 200, including the generator network 204, the discriminator network 216, the processor 226, and the data exporter 236. As the method 500 is executed, the first neural network and the second neural network, i.e., the generator network 204 and the discriminator network 216, are physically co-located or located within a same geographic region.

The flow chart 500 begins by the data generator 206 generating a synthetic data set, such as the synthetic data 214, based on an original data set, such as the original input data 202, received by the generator network 204. In some implementations, the generator network 204 is referred to as a first neural network. The original input data 202 can be provided as a dataset X including m rows and n columns. The synthetic data 214 is generated by distorting the feature values of the original input data 202 to introduce noise and create synthetic data values which are close to those of the original input data 202 without any meaningful reconstruction of the original data that could identify an individual, a consumer, a group, and so forth as in the original input data 202.

In operation 503, the processor 226 provides the original input data 202 and the synthetic data 214 to the discriminator network 216. In some implementations, the discriminator network 216 is referred to as a second neural network. The provided original input data 202 and synthetic data 214 can be labeled versions that mask which is the original data and which is the synthetic data. For example, the processor can randomly assign a label to each of the original data 202 and the synthetic data 214 and provide the labeled original data 202 and the synthetic data 214 to the discriminator network 216. The labels can comprise a 0 or a 1. In other words, either the original data 202 is labeled with a 1 and the synthetic data 214 is labeled with a 0, or the original data 202 is labeled with a 0 and the synthetic data 214 is labeled with a 1.

In operation 505, the discriminator network 216 generates a prediction regarding which of the original input data 202 and the synthetic data 214 is the original data and which of the original input data 202 and the synthetic data 214 is the synthetic data. The discriminator network 216 generates the prediction by alternating affine and non-linear activation functions, reducing in dimensionality to the last layer, as described herein. The generated prediction is output to the processor 226.

In operation 507, the processor 226 determines whether the generated prediction is correct. In other words, the processor 226 determines whether the discriminator network 216 correctly identified the original data set and the synthetic data set. In implementations where the generated prediction is correct, the flow chart 500 proceeds to operations 509. In operation 509, each of the ML model 208 and the ML model 220 calculate a loss by subtracting a gradient of the calculated loss and minimizing values in an opposite direction of the gradient. In operation 511, each of the generator network 204 and the discriminator network 216 update parameters to more accurately generate the synthetic data 214 and generate predictions, respectively. Because the discriminator network 216 correctly identified the original input data 202 and the synthetic data 214, the synthetic data 214 is characterized as not realistic enough to be used to train an external ML model. The flow chart 500 then returns to operation 501 and generates an updated synthetic data set based on the updated parameters.

In implementations where the generated prediction is incorrect, the flow chart 500 proceeds to operation 513. In operation 513, each of the ML model 208 and the ML model 220 calculate a loss by subtracting a gradient of the calculated loss and minimizing values in an opposite direction of the gradient. In operation 515, each of the ML model 208 and the ML model 220 update parameters to more accurately generate the synthetic data 214 and generate predictions, respectively. Because the discriminator network 216 incorrectly identified the original data and the synthetic data 214, the synthetic data 214 is characterized as realistic enough to be used to train an external ML model. The flow chart 500 then proceeds to operation 517, where the data exporter 236 exports the synthetic data 214 to an external ML model for use in training the ML model.

Pseudocode that, in some implementations, corresponds to the flow chart 500 is provided below.

Initialize parameters of the Discriminator and Generator networks are to random value i.e. all values of Wₖ and W_{final} and Hₖ and all the bias terms B are initialized to random values.
num_epochs=100
batch_size=32
num_batches=num_observations/batch_size
for epoch in range (1:num_epochs):
   for batch in range (1:num_batches):
      1. Compute forward pass of the generator network as:

G_{X}=ReLU(Wₖ(ReLU(Wₖ₋₁( . . . ReLU(W₀X+B₀)

Generator_{X}=σ(W_{final}·G_{X}+b_{X})
2. Input to the discriminator network as the concatentation of X and G_{X}as X,G_{X}=[X|G_{X}]
3. Calculate the forward pass for the discriminator as:

Discriminator_{X,G}_{_{X}}=σ(Hₖ(ReLU(Hₖ₋₁( . . . ReLU(H₀[X|G_{X}]+B₀)
4. Computer the discriminator loss as:

Loss_{D}=−[X|G_{X}]*log(Discriminator_{X,G}_{_{X}})−(1−[X|G_{X}])*(1 −log(Discriminator_{X,G}_{_{X}}))
5. Compute the generator loss as:

Loss_{G}=−X*log(Discriminator_{X,G}_{_{X}})−(1−X)*(1−log(Discriminator_{X,G}_{_{X}}))
6. Differentiate the losses simultaneously w.r.t the unknows Wₖ and W_{final} and Hₖ and all the bias terms B
7. Back-propagate the loss by subtracting the gradients of the loss and thereby minimizing the values of Wₖ and W_{final} and Hₖ and all the bias terms B in the opposite direction of the gradient

### Additional Examples

Some examples herein are directed to a method of deep reinforcement learning, as illustrated by the flow chart 500. The method (500) includes generating (501), by a first neural network (204) implemented on a processor (226), a synthetic data set (214) based on an original data set (202), providing (503) the original data set and the generated synthetic data set to a second neural network (216) implemented on the processor, generating (505), by the second neural network, a prediction identifying the original data set and the generated synthetic data set, and based at least in part on the prediction incorrectly identifying the generated synthetic data set, exporting (517) the generated synthetic data set.

In some examples, the method further includes based at least in part on the prediction correctly identifying the generated synthetic data, executing, by the first neural network, a machine learning model to calculate (509) a loss for the generated synthetic data set and update (511) parameters for the generated synthetic data set, and generating, by the first neural network, a second synthetic data set.

In some examples, the method further includes updating, by the first neural network, the parameters by subtracting a gradient of the calculated loss and minimizing values in an opposite direction of the gradient.

In some examples, the method further includes based at least in part on the prediction incorrectly identifying the generated synthetic data set, executing, by the second neural network, a machine learning algorithm to calculate (513) a loss for the second neural network and update (515) parameters for the second neural network.

In some examples, the method further includes updating, by the second neural network, the parameters by subtracting a gradient of the calculated loss and minimizing values in an opposite direction of the gradient.

In some examples, the method further includes randomly assigning a label to each of the original data set and the generated synthetic data set, and providing the labeled original data set and the generated synthetic data set to the second neural network.

In some examples, to generate the prediction, the method further includes alternating affine and non-linear activation functions.

In some examples, to generate the synthetic data set, the method further includes distorting feature values of the original data set to introduce noise.

In some examples, the first neural network and the second neural network are physically co-located or located within a same geographic region.

Although described in connection with an example computing device 100 and system 200, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, servers, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality (MR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one example or may relate to several examples. The examples are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

What is claimed is:

1. A system for deep reinforcement learning, the system comprising:
a processor;
a first neural network implemented on the processor;
a second neural network implemented on the processor; and
a memory storing instructions that, when executed by the processor, cause the processor to:
control the first neural network to generate a synthetic data set based on an original data set,
provide the original data set and the generated synthetic data set to the second neural network,
control the second neural network to generate a prediction identifying the original data set and the generated synthetic data set, and
based at least in part on the prediction incorrectly identifying the generated synthetic data set, export the generated synthetic data set.

2. The system of claim 1, wherein the instructions further cause the processor to:
based at least in part on the prediction correctly identifying the generated synthetic data, control the first neural network to execute a machine learning model to calculate a loss for the generated synthetic data set and update parameters; and
using the updated parameters, control the first neural network to generate a second synthetic data set.

3. The system of claim 2, wherein the instructions further cause the first neural network to update the parameters by subtracting a gradient of the calculated loss and minimizing values in an opposite direction of the gradient.

4. The system of claim 1, wherein the instructions further cause the processor to:
based at least in part on the prediction incorrectly identifying the generated synthetic data set, control the second neural network to execute a machine learning algorithm to calculate a loss for the second neural network and update parameters.

5. The system of claim 4, wherein the instructions further cause the second neural network to update the parameters by subtracting a gradient of the calculated loss and minimizing values in an opposite direction of the gradient.

6. The system of claim 1, wherein the instructions further cause the processor to:
randomly assign a label to each of the original data set and the generated synthetic data set,
provide the labeled original data set and the generated synthetic data set to the second neural network, and
receive the prediction generated by the second neural network.

7. The system of claim 1, wherein the instructions further cause the first neural network to generate the synthetic data set by:
distorting feature values of the original data set to introduce noise.

8. The system of claim 1, wherein the instructions further cause the second neural network to:
generate the prediction by alternating affine and non-linear activation functions.

9. The system of claim 1, wherein the first neural network and the second neural network are physically co-located or located within a same geographic region.

10. A computer-implemented method for deep reinforcement learning, the method comprising:
generating, by a first neural network implemented on a processor, a synthetic data set based on an original data set;
providing the original data set and the generated synthetic data set to a second neural network implemented on the processor;
generating, by the second neural network, a prediction identifying the original data set and the generated synthetic data set; and
based at least in part on the prediction incorrectly identifying the generated synthetic data set, exporting the generated synthetic data set.

11. The computer-implemented method of claim 10, further comprising:
based at least in part on the prediction correctly identifying the generated synthetic data, executing, by the first neural network, a machine learning model to calculate a loss for the generated synthetic data set and update parameters for the generated synthetic data set; and
generating, by the first neural network, a second synthetic data set.

12. The computer-implemented method of claim 11, further comprising:
updating, by the first neural network, the parameters by subtracting a gradient of the calculated loss and minimizing values in an opposite direction of the gradient.

13. The computer-implemented method of claim 10, further comprising:
based at least in part on the prediction incorrectly identifying the generated synthetic data set, executing, by the second neural network, a machine learning algorithm to calculate a loss for the second neural network and update parameters for the second neural network.

14. The computer-implemented method of claim 13, further comprising:
updating, by the second neural network, the parameters by subtracting a gradient of the calculated loss and minimizing values in an opposite direction of the gradient.

15. The computer-implemented method of claim 10, further comprising:
randomly assigning a label to each of the original data set and the generated synthetic data set, and
providing the labeled original data set and the generated synthetic data set to the second neural network.

16. The computer-implemented method of claim 10, wherein generating the prediction further comprises:
alternating affine and non-linear activation functions.

17. The computer-implemented method of claim 10, wherein generating the synthetic data set further comprises:
distorting feature values of the original data set to introduce noise.

18. The computer-implemented method of claim 10, wherein the first neural network and the second neural network are physically co-located or located within a same geographic region.

19. One or more computer-storage memory devices embodied with executable operations that, when executed by a processor, cause the processor to:
receive an original data set;
control a first neural network to generate a first synthetic data set based on the original data set;
provide the original data set and the generated first synthetic data set to a second neural network;
control the second neural network to generate a first prediction identifying the original data set and the generated first synthetic data set;
based at least in part on the first prediction correctly identifying the generated synthetic data set:
control the first neural network to execute a first machine learning (ML) model to calculate a loss for the generated first synthetic data set, update parameters, and, using the updated parameters, generate a second synthetic data set, wherein the generated second synthetic data set is a second iteration of the generated first synthetic data set based on the original data set, and
control the second neural network to execute a second ML model to calculate a loss for the second neural network and update parameters;
provide the original data set and the generated second synthetic data set to the second neural network;
control the second neural network to generate a second prediction identifying the original data set and the generated first synthetic data set; and
based at least in part on the second prediction incorrectly identifying the generated second synthetic data set, export the generated second synthetic data set.

20. The one or more computer-storage memory devices of claim 19, wherein the processor further:
exports the generated second synthetic data set to a third ML model.
